(19) United States
(12) Patent Application Publication
(10) Pub. No.: US 2013/0091442 A1
(43) Pub. Date: Apr. 11, 2013

(54) Global Account Configuration Instances

(71) Applicant: BROADCOM CORPORATION, Irvine, CA (US)

(72) Inventor: Wael William Diab, San Francisco, CA (US)

(73) Assignee: BROADCOM CORPORATION, IRVINE, CA (US)

(21) Appl. No.: 13/622,239

(22) Filed: Sep. 18, 2012

Related U.S. Application Data
(60) Provisional application No. 61/545,147, filed on Oct. 8, 2011.

(51) Int. Cl. G06F 3/01

(52) U.S. Cl. 715/753

(57) ABSTRACT

A networking system supports dynamic management of representations of interactions between network members and resources based on global representations of the interactions. Representative views of the interactions for various devices associated with members and network accounts can be managed based on the global representation and configuration information. Representative views can be accessed simultaneously from separate devices, and upon accessing a network from supporting devices, enabling seamless transitions between supporting devices. Members can be provided an option of accessing interactions and engaging in new interactions. Multiple instances of resources can be distributed and provided to members based on locations, energy usage associated with supporting the interactions, and capabilities of devices associated with members. Interactions by various associated devices can be managed, controlled, and restricted based on configuration information.

### CROSS REFERENCE TO RELATED PATENTS/PATENT APPLICATIONS

### Provisional Priority Claim

The present U.S. Utility Patent Application claims priority pursuant to 35 U.S.C. §119(e) to the following U.S. Provisional Patent Application which is hereby incorporated herein by reference in its entirety and made part of the present U.S. Utility Patent Application for all purposes:
1. U.S. Provisional Patent Application Ser. No. 61/545,147, entitled “Social Network Device Memberships and Resource Allocation,” (Attorney Docket No. BP23771), filed Oct. 8, 2011, pending.

### Incorporation by Reference

The following U.S. Utility Patent Application is hereby incorporated herein by reference in its entirety and made part of the present U.S. Utility Patent Application for all purposes:
1. U.S. Utility Application Ser. No. ______, entitled “GREEN HOSTING METHODOLOGIES,” (Attorney Docket No. BP23828), filed on the same date herewith, pending, which claims priority pursuant to 35 U.S.C. §119(e) to the following U.S. Provisional Patent Application:
   1.1. U.S. Provisional Patent Application Ser. No. 61/545,147, entitled “Social Network Device Memberships and Resource Allocation,” (Attorney Docket No. BP23771), filed Oct. 8, 2011, pending.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

1. Field of the Invention

This invention relates generally to social networking, and more particularly to social network device memberships, content hosting and storage, resource allocation, and related services and communications.

2. Related Art

In many popular social networks, especially profile-focused social networks, activity centers on web pages or social spaces that enable members to view profiles, communicate and share activities, interests, opinions, status updates, audio/video content, etc., across networks of contacts. Social networking services might also allow members to track certain activities of other members of the social network, collaborate, locate and connect with existing friends, former acquaintances and colleagues, and establish new connections with other members.

Individual members typically connect to social networking services through existing web-based platforms via a computing device, tablet or smartphone. Members often share a common bond, social status, or geographic or cultural connection with their respective contacts. Smartphone and games-based mobile social networking services are examples of rapidly developing areas.

In so-called “cloud” computing, computing tasks are performed on remote computers/servers which are typically accessed via Internet connections. One benefit of cloud computing is that may reduce the relative processing and storage capabilities required by user devices (e.g., a cloud computer may load a webpage accessed by a tablet device and communicate only required information back to the tablet). Accordingly, recent years have witnessed an ever-growing amount of content and application software being migrated from local or on-site storage to cloud-based data storage and management. Such software functionality/services and content are typically available on-demand via (virtualized) network infrastructures.

In traditional social networks, interactions involving various applications and services often employ simplistic, location or regional-based approaches. For example, load balancing involving content hosting is typically performed by servers based on traffic considerations. Infrastructure is often designed for peak consumption, and generally needs to accommodate the highest capacity demand. Peak demand, however, typically occurs for a relatively short duration and it can be difficult to predict when peaks/troughs will occur. Over-provisioning of resources to meet short periods of high demand might prove too costly for many systems. In addition, users may sometimes travel great distances, but data associated with a user typically remains in a static location, which can make data access time-consuming and costly. Furthermore, interactions with social resources through various devices can involve re-establishing a view of such resources upon switching between devices, which can prove bothersome.

### BRIEF DESCRIPTION OF THE DRAWINGS

FIG. 1 illustrates a schematic block diagram of a social networking environment according to various embodiments;

FIG. 2 illustrates a logic diagram of a process for supporting network element management according to various embodiments;

FIG. 3 illustrates a schematic block diagram of a social networking environment according to various embodiments;

FIG. 4 illustrates a logic diagram of a process for supporting interactions with resources associated with a network and various devices associated with one or more network member accounts in accordance with various embodiments;

FIG. 5 illustrates a schematic block diagram of a social networking environment according to various embodiments;

FIG. 6 illustrates a schematic block diagram of a social circle environment in accordance with various embodiments; and

FIG. 7 illustrates a schematic block diagram of an embodiment of a social device or server comprising functionality operable to support interactions with resources associated with social circles/sub-circles in accordance with various embodiments.

### DETAILED DESCRIPTION OF THE INVENTION

As used herein, the terms “social network”, “SNET”, “social networking system”, “social networking infrastructure”, and the like, comprise a grouping or social structure of devices and/or individuals, as well as connections, links and interdependencies between such devices and/or individuals. Members or actors (including devices) within or affiliated with an SNET may be referred to herein as “members”, “users”, “membership”, “nodes”, “social devices”, “SNET members”, “SNET membership”, “SNET devices”, “user devices” and/or “modules”. In addition, the terms “social circle”, “social group”, “SNET circle”, “SNET sub-circle”, “SNET group”, and “SNET sub-group” generally denote an SNET that comprises SNET devices and, as contextually appropriate, human SNET members, device SNET members, personal area networks (“PAN”), and the like. As used herein, the term “resource” is intended to encompass at least content, which can include of one or more types of content, including, without restriction, audio content, video content, graphics, and text, and capabilities provided via various SNET members, services, applications, and associated devices. Interaction with resources can include accessing resources and providing resources. A processing system can include, without limitation, one or more instances of processing circuitry distributed across one or more server devices, network nodes, some combination thereof, or the like.

Network infrastructures are generally configured to accommodate a peak level of interaction activity, enabling the infrastructures to support the likely highest level of usage of network elements, including interaction with resources associated with the network. Such a peak level for demand, however, tends to occur for only short durations of time, and can be difficult to anticipate. Furthermore, configuring a network infrastructure to accommodate peak levels of interaction activity can be expensive, and result in a system that wastes resources and energy to support lesser levels of interaction activity. For example, a network infrastructure may be configured to host content uploaded by a user at a hosting location that is proximate to the user, but is unable to efficiently handle access to the content by a large number of users at any given time. In addition, a network infrastructure may be configured to host all uploaded content, services, and applications from a central server, which requires extensive routing and energy consumption for interaction with hosted resources by various dispersed users.

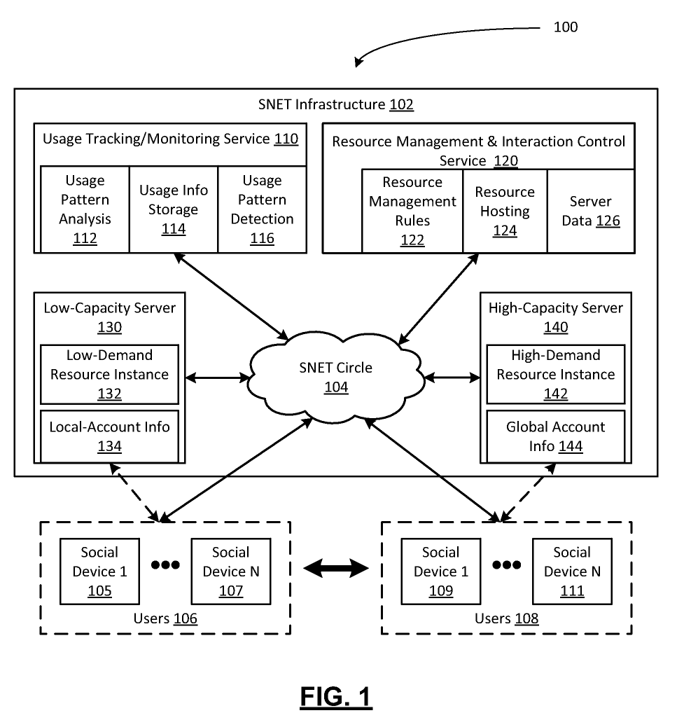

Referring first to FIG. 1, a social network (“SNET”) 100 according to various embodiments is illustrated and discussed. SNET 100 includes an SNET infrastructure 102 that is configured to manage various elements based on interaction activity by various SNET users. SNET infrastructure 102 includes usage tracking and monitoring service 110 and resource management and interaction control service 120. SNET infrastructure 102 can also include one or more resource hosting locations, including servers 130 and 140, which can host instances 132 and 142 of one or more resources, information 134 and 144 associated with various portions of SNET accounts, etc. Elements of a network infrastructure, such as SNET infrastructure 102, can support interactions between various users and resources associated with the network infrastructure. For example, in the illustrated embodiment, elements 110, 120, 130, and 140 of SNET infrastructure 102 support interactions between users 106 and 108 and various resources, services, and applications provided via an SNET circle 104. As used herein, the term “resources” or “social resources” encompasses both device level and network infrastructure level (cloud/server) devices, services, software and other functionality, and can include group multicasting functionality, transcoding, services, applications, one or more instances of media and other content, content storage/caching/servers, trans-cryption, capture elements (microphones, cameras, mechanical mounting controls), profile information, services and applications provided by network infrastructure, capabilities provided by various other users and docked devices, and the like. Network users can interact with resources via one or more devices supporting the users, as shown in FIG. 1.

In some embodiments, a network infrastructure, which can include one or more processing systems, supports monitoring of interactions between members of a network and various resources and managing various elements of the network infrastructure based on some or all of the monitored interactions, also referred to herein as “interaction activity” and “usage”. Elements of a network infrastructure can include, without limitation, hosting locations, processing systems, ports, drives, etc. In some embodiments, at least a portion of a network infrastructure can be virtualized. Virtualized infrastructure can include one or more virtual devices, which can implement various processes, programs, functionality, and the like. For example, a network infrastructure element, including, without limitation, a processing system, can include one or more virtual server devices that each can implement server device functionality. Monitored interactions can include usage of certain resources, access of certain content items and resources associated with certain services, applications, users, SNET circles, devices, etc. Interaction activity can be monitored via one or more network infrastructure and third-party services and applications.

For example, as shown in FIG. 1, SNET infrastructure 102 includes Usage Tracking and Monitoring Service 110, which can monitor and track interactions between network users and resources. Usage can be tracked by number of clicks or actions with reference to a resource, frequency of usage on a per-user basis, frequency of usage by some or all of a selected population, usage over a period of time or locality, etc. Usage Tracking and Monitoring Service 110 can include a usage pattern analysis module 112, which can monitor interactions to analyze and identify certain patterns in interaction activity. Patterns can be associated with certain content items, resources associated with certain users and SNET circles, certain locations, events, etc. For example, module 112 can be used to identify usage patterns associated with certain selections of content associated with an SNET circle and certain activities associated with the SNET circle. In addition, usage patterns associated with locations of users and network elements, including server devices, can be tracked. Usage information storage module 114 can manage storage of interaction information, including information to identify interaction activity patterns. Usage pattern detection module 116 can manage analysis of interaction activity to detect one or more known patterns of interaction activity. Analysis of interaction activity can occur in real-time, periodically, intermittently, in response to certain events or prompts, etc. Patterns can be detected as they occur; in some embodiments, certain patterns can be anticipated via the detection of other patterns.

In some embodiments, various elements of a network infrastructure adapt to interaction activities involving various resources associated with the network, and capabilities of various elements in the network infrastructures. Element management can include, without limitation, reprogramming or restructuring policies (e.g., at the chip or port level), selectively utilizing elements of the infrastructure, distributing resources or content across network elements, selectively activating or deactivating network elements, routing communications, etc. In the illustrated embodiment, for example, resource management and interaction control service 120 manages network resources and interactions based on resource hosting location data and interaction activity data. Service 120 can include multiple modules, including resource management rules 122, which can manage various responses and management actions with regards to certain patterns of interaction activity.

In some embodiments, performance and capabilities associated with network elements can be collected and analyzed to determine the capability of the elements to support certain patterns of interaction activity. For example, in the illustrated embodiment, server data module 126 can support analysis of capability information associated with network hosting locations, including servers 130 and 140. Such information can include server bandwidth, energy usage, etc. and can be determined by monitoring various aspects of network elements, including, without limitation, bandwidth, energy usage, storage capacity, and the like. Capability information can also be determined or estimated by simulating support of certain patterns of interaction activities. Simulations can be performed by the relevant network elements in a virtual processing system, by a dedicated network element that simulates performance of other network elements, or the like. For example, in some embodiments, a network infrastructure includes one or more virtual devices, including, without limitation, one or more virtual server devices, which can support determining capabilities of various network infrastructure elements, including simulating performance of various non-virtual devices in supporting certain patterns of simulation activities.

In some embodiments, elements of the network infrastructure support re-configuring elements of the network infrastructure, based upon identified interaction activity patterns, to optimize use of network elements to support the patterns. In some embodiments, patterns are anticipated, and elements are configured to support the anticipated patterns in interaction activity. Elements can be reconfigured dynamically in response to real-time variations in interaction activity; configurations can also be made on a periodic or intermittent basis.

For example, as shown in the illustrated embodiment, resource hosting module 124 can utilize resource management rules, along with hosting location information, to manage resource hosting based on interaction activity patterns detected by service 110. Hosting locations can be selected based on various aspects of the locations, including proximity to users determined to be most likely to interact with a hosted resource, bandwidth capacity of the hosting location, likely energy usage associated with supporting anticipated interaction activity, etc. For example, as shown in the illustrated embodiment, where server 130 has a lesser bandwidth capacity than server 140, and service 110 detects that, based on detection of a known interaction activity pattern, certain users 108 are anticipated to exhibit heavy demand for interaction with a resource for a period of time, while certain users 106 are anticipated to exhibit low demand for interaction with the resource, service 120 can distribute a high-resolution instance 132 of the resource to be hosted by the low-capacity server 130 for access by the likely low-demand users 106, while a low-resolution instance 142 of the resource is distributed to be hosted by the high-capacity server 140 for access by the likely high-demand users 108. Such distributions can be temporary, based on variations in interaction activity, and instances of the resource distributed on various hosting locations can include instances in different formats to accommodate likely activities and capabilities of devices supporting various users. For example, certain regional or global high-bandwidth hosting locations can be activated at will to support periods of high levels of interaction activity associated with certain resources, and then deactivated when the interaction activity falls back to levels that can be more efficiently supported by local, low-bandwidth hosting locations. In another embodiment, server 140 can be a high-capacity “excess demand” server that is activated and deactivated as demand for resources fluctuates over time.

In some embodiments, network element use can be optimized to maximize energy efficiency of the infrastructure, of various elements of the infrastructure, of selected devices, or the like. For example, where server 130 is sufficient to meet usage demands of users 106 and 108, resources can be exclusively hosted at server 130; where server 130 is not sufficient to meet usage demands, including, without limitation, supporting interactions by users in various remote locations, high levels of interaction activity by some or all users 108 of the network, and temporary high levels of interaction with certain resources, service 120 can respond to anticipation of such fluctuations in interaction activity by distributing one or more instances of the resources to be hosted by one or more other hosting locations, such as server 140. Instances can have similar or different formats, to enable optimal energy usage by both network elements and user devices, such as social devices 105, 107, 109, and 111. In some embodiments, network elements can be configured to optimize quality of service (“QoS”), access bandwidth, etc. Optimization targets can be established by an infrastructure service or a user. For example, a user may interact with a network to manually command the network to manage resource hosting to optimize resolution of media content accessed by the user, regardless of energy usage by network elements or devices supporting the user.

In some embodiments, various modules associated with various services and applications can be distributed or aggregated as desired. For example, Resource Management and Interaction Control Service 120 can also include a usage pattern detection 116 module, in addition to or in place of a similar module in usage tracking and monitoring service 110, to optimize infrastructure performance as needed.

In some embodiments, dynamic management of network elements includes managing resources based on shifts in locations associated with users. Such management can include distributing selected portions of resources to optimize interactions based on anticipated interaction activity. For example, where a user is determined to access certain resources, such as certain media content, more often than others, a network infrastructure may distribute instances of the media content to hosting locations that are local to the present location of one or more devices supporting the user. The network infrastructure can also distribute instances to be stored locally on the one or more devices when the user is anticipated to be shifting to a location where a device supporting the user would have to expend undesirable amounts of energy to access media content that could simply be stored by the device itself. For example, where a member of a SNET who is docked to an SNET circle has a home location in the United States, various resources associated with the member's SNET account, such as profile information and user-uploaded content, may be hosted at hosting locations proximate to the user's home location, to minimize energy usage associated with interacting with such resources. In such an example, the SNET infrastructure may respond to determining that the user has shifted location—to another country, for example—by distributing portions of the resources associated with the member's account to hosting locations that are proximate to the user's new location. Distributed portions can include instances of resources that the SNET infrastructure anticipates will be accessed by the member while in the new location, including basic profile information and data associated with services and applications that the member is found to utilize regardless of location.

In some embodiments, various resources associated with a user's network profile can be distributed across multiple hosting locations based on interaction activities associated with the resources. Such resources can include portions of a user's network profile information, selected content items, services, and applications with which the user is determined to interact in a certain pattern. For example, as shown in the illustrated embodiment, some portions of a user's account information 134, such as profile information and certain content items that the user is determined to interact with at a high frequency, may be hosted at a local hosting location, such as a server 130 that is proximate to the user's likely location. Where an element of the SNET infrastructure, such as the server 110, determines that the user is shifting location, instances of information 134 can be distributed to additional hosting locations proximate to the user's new location. Such locations can include one or more memories of devices supporting the user. For example, where a user is anticipated to change location, instances of content items that the user is determined to access on a regular basis can be transferred to local storage of a device supporting the user. Such distributions can be temporary, and instances distributed to other hosting locations can be removed after a period of time, after the user changes location again, etc. As a result, the resources that are most often interacted with by the user can be distributed to hosting locations that enable interactions that optimize energy usage. In another example, resources that are accessed sparingly or by a small number of users can be hosted in a low-bandwidth hosting location, such as server 130, while resources that are utilized often, or by a large number of users, can be hosted in a high-bandwidth hosting location, such as server 140.

In some embodiments, interaction rules and capabilities associated with various devices coupled to a network can be managed based on various patterns of interaction activity. Interaction with certain resources by a certain device supporting a user can be restricted based upon a location associated with the device, such that the device is restricted from performing certain energy-intensive interactions with network resources. For example, where a user is in a remote location, a device supporting the user can be restricted from automatically synchronizing with various network services and applications. The device can also be restricted from automatically accessing certain instances of resources, including, without limitation, high-resolution media content items. In another example, the user's device can be restricted from performing automatic synchronization based upon the local time, or current interactions supported by the device. In some embodiments, restrictions are determined based on configurations in a user's network account, where restrictions can be imposed on some or all devices associated (or “docked”) with the user's account, certain circles in a network, etc. Such restrictions can be made based on interaction rights, which can include location-based interaction rights, time-based interaction rights, etc. For example, where an account is associated with a “subscription” to various resources associated with the network or third-parties, restrictions can include limitations on number of interactions with selected resources including, without limitation, restrictions on numbers of accesses of instances of certain content items. Such rights can be set by default and managed for some or all users by a network infrastructure; the rights may also be managed on a per-user basis by the user and associated users. For example, where a member of a social network has a smartphone and a television docked with a certain SNET circle, the member can configure his account to restrict his smartphone from engaging in certain energy-intensive interactions, such as automatically interacting with a cloud storage location, based on time of day, location of the device, etc. The device may provide location information, such as GPS data, to elements of the network infrastructure, which manage interaction restrictions on the device based on such information and account configurations. A user may configure his account to restrict access to content the user uploads to an SNET circle to selected SNET members, such as members in proximity to a certain location, identified family or friends, or the like. In addition, the user can configure his account to impose few or no restrictions on interactions by devices such as a docked television.

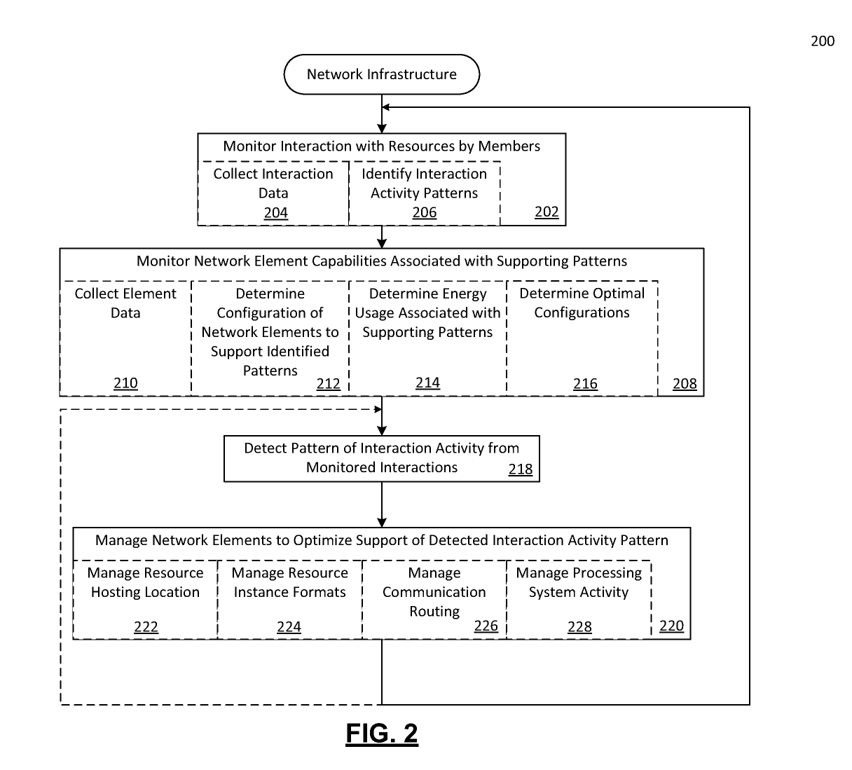

FIG. 2 is a logic diagram of a process 200 for supporting network element management through automatic or manual processes in accordance with various embodiments. In some embodiments, process 200 is performed, in part or in full, by elements of a network infrastructure, SNET infrastructure, or the like, including services and applications supported by central or distributed processing systems. As shown in block 202 of the illustrated embodiment, process 200 includes monitoring interactions between various members and resources. Monitoring can include, without limitation, collecting interaction data and analyzing interaction data to identify interaction activity patterns, as illustrated by blocks 204 and 206. As shown in block 208, process 200 can include monitoring various network infrastructure element capabilities associated with supporting various patterns of interaction activity. As shown by blocks 210-216, such monitoring can include collecting data associated with the elements, determining various configurations of network elements to support known interaction activity patterns, determining energy usage associated with supporting the known patterns via the determined configurations, and determining optimal configurations based on various factors. Optimal configurations can be determined based on various aspects; for example, configurations that optimize energy usage by some or all network elements, configurations that optimize quality of service, etc.

As shown in block 218, process 200 can include identifying a known pattern of interaction activity from monitored interactions. Monitored interactions can be compared with a database of known interaction activity patterns, where patterns are detected from correlations between monitored interactions and known interaction activity patterns. Such monitoring, and updating of the database, can be performed continuously, intermittently, occasionally, and in response to certain events or prompts.

As shown in block 220, process 200 can include managing various network elements to optimize support of an identified pattern of interaction activity. As shown by blocks 222-228, such management can include, without limitation, managing locations at which instances of resources are hosted, managing formats of various hosted instances, managing communication pathways involved in interactions between hosted resource instances and members, and managing activities and performance of various network elements. Managing network element performance can include selectively activating and deactivating usage of selected server devices, nodes, ports, drivers, etc. Network elements can be managed by being configured to optimize some aspect of network performance, including energy usage of network elements. In addition, management can include managing interaction rights and capabilities associated with various devices associated with the network. For example, as discussed above, various interaction rights can be restricted based upon time of day, location associated with the device, etc.

As shown in the illustrated embodiment, process 200 can include repeating some or all of the illustrated elements on a continuous or intermittent basis. For example, network capabilities and known interaction activity patterns can be monitored and updated on a predetermined intermittent schedule, while interactions can be monitored to detect known interaction activities, and network elements managed to support detected interaction activities, on a continuous basis.

In some embodiments, network infrastructures can manage interactions with resources to harmonize user transitions between devices, applications, and the like by members. Members may switch back and forth between devices while interacting with one or more resources, including, for example, media content items streamed from cloud storage, services and applications accessed via social networks, etc. A member can interact with resources through a given device via a representation, or “representative view” that is provided. The representative view can include a representation of some or all of a network, including, without limitation, an SNET circle and resources associated with some portion of the network or third parties. In addition, a representative view can include a representation of an interaction activity. Where a user is accessing a portion of a resource associated with an SNET circle, a representative view can include a representation of the resource and the user's interactions with the resource. For example, where a user's interactions with a resource include viewing a video content item streamed from a third-party service via an SNET circle to which the user is linked, the representative view of the interaction activity can include a real-time view of the portion of the video content item, and one or more other various network resources, that is currently being viewed by the viewer. In some embodiments, multiple members associated with an account can access a representative view of an interaction by one of the members with various resources to follow the interaction. One or more members can also access multiple representative views of the interaction activity on multiple devices.

In some embodiments, when the member switches to a different device and attempts to re-establish interaction with the same resources, the representative view provided via the different device can provide interaction with the resources without requiring the member to spend excess time re-establishing access, essentially providing a “seamless” or near-seamless transition between devices with regards to the interaction.

For example, where a member accesses a video content item from cloud storage via a representative view of a media service/content on a first device, and then switches to a second device in the midst of viewing the video content item, the member is able to continue viewing the same video content item, via the representative view provided to the second device, by simply accessing the media service via the second device; the video content item is then streamed to the user from the point in the video content item at which the user switched devices, without requiring the user to manually select the video content item from the service, and skip to the relevant point. In some embodiments, the resources are provided to a user, via an account, such that the user can simultaneously interact with the resources via multiple devices, without any breaks in access. A global configuration instance, or “global representation” associated with a user's network account can include a global instance or representation of the member's interaction with resources. The global configuration instance can be used to support interactions by any devices associated with the member's account. Representative views provided to some or all associated devices can utilize the global instance configuration to provide simultaneous access to the same resources, regardless of which device is used. A global representation can be, in some embodiments, a form of “global cookie” associated with a member's account.

A global configuration instance can include information to configure resource interactions on a per-device basis, to optimize various aspects of interaction, including energy usage by the device, bandwidth usage, device capabilities, etc. A network infrastructure can utilize the global account configuration to distribute and format instances of resources to enable optimized access to the same resources by various devices associated with a user. For example, instances of a resource provided to a second device may be of a lower quality than instances provided to a first device, depending upon capabilities of the devices.

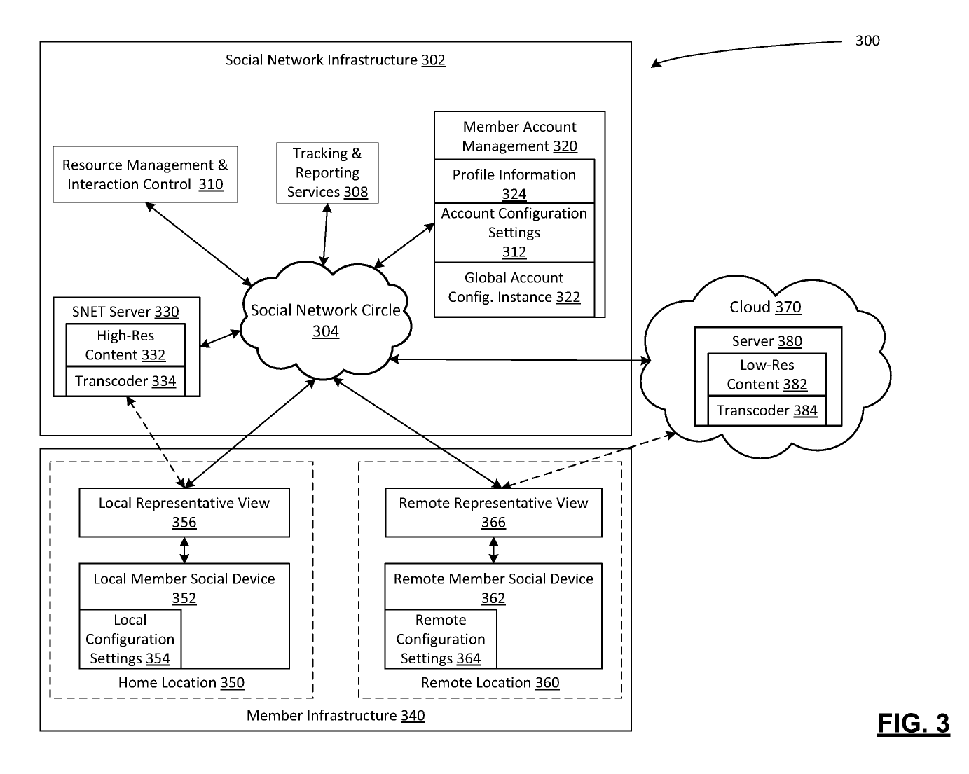

Referring to FIG. 3, a social network (“SNET”) 300 according to various embodiments is illustrated and discussed. SNET 300 can include an SNET infrastructure 302 that includes elements configured to manage interactions with resources by one or more network members via multiple devices and multiple locations. For example, as shown in the illustrated embodiment, SNET infrastructure 302 can support interactions between a member associated with a member infrastructure 340 and resources associated with SNET circle 304, including, without limitation, content hosted at various hosting locations. In some embodiments, elements of a network infrastructure can manage a global configuration instance of a member account to support seamless interaction with one or more resources via multiple devices. As shown in the illustrated embodiment, for example, member account management 320 can include a global account configuration instance 322 associated with a given member's account. The configuration instance can include information that characterizes the member's interaction with resources associated with SNET circle 304 at any time. For example, where a member of infrastructure 340 is accessing a high-resolution instance of content item 332 via a social device 352, the global account configuration instance 322 can indicate that the member is accessing an instance of content item 332. The global account configuration instance 322 can be updated continuously based on the member's interactions; for example, where the member is accessing a video content item, the global account configuration instance can identify the specific content item accessed and track the portions accessed by the member. The global account configuration instance can also include a history of interactions. The global account configuration instance 322 can be updated via a tracking and reporting service 308, which can monitor interactions between members of SNET circle 304 and resources associated with SNET circle 304 and update the global account configuration instance.

In some embodiments, various representative views of portions of SNET circle 304, which can include representative views of resources associated with SNET circle 304, can be provided to each device supporting a member that is docked with the SNET circle 304. Each representative view can be configured to support interaction with resources associated with SNET circle 304 in a manner optimized for the particular device. For example, in the illustrated embodiment, where member infrastructure includes a social device 352 and social device 362, a representative view 356 can be configured for interactions with SNET circle 304 via for device 352, and a representative view 366 can be configured for interactions with SNET circle 304 via for device 362. Information needed to properly configure each representative view can be determined from account configuration settings 312, which can be configured by one or more members and elements of the SNET infrastructure 302. For example, configuration settings 312 for devices associated with infrastructure 340 can include interaction controls and restrictions, along with optimal formats for certain content items accessed via the devices. The configuration settings 312 can be used to configure representative views that support optimal interaction conditions, including, without limitation, optimized energy usage by one or more devices and network elements, optimal QoS for interaction with a resource, etc.

In further embodiments, configuration settings 312 can be stored in a network infrastructure and applied to devices associated with an account. In addition, configuration settings, along with other information, can be stored in a local memory of devices supporting a member. For example, as shown in the illustrated embodiment, device 352 can include, in a storage location, configuration settings 354 that indicate optimal formats and interaction rules associated with the device. Upon docking with SNET circle 304, device 352 can provide the settings 354 to proximate SNET infrastructure 302 elements to be used to support optimal interactions with desired resources. Other devices in a member's infrastructure 340, such as the illustrated device 362, can include configuration settings 364 associated with the device 362, along with other devices and account settings.

In some embodiments, account configuration settings 312 can be used, along with the global account configuration instance 322, to support seamless transitions between devices by providing real-time representative views of a member's interactions with resources via multiple devices. As noted above, the global account configuration instance 322 can provide representation of a member's interactions with resources in real-time, and network elements can utilize the instance 322, along with configuration settings 312, to provide a representative view of such interaction to any desired device, including some or all devices 352 and 362 associated with the member that are docked to the SNET circle. Representative view 356 or 366 can be provided to a user to automatically resume an interaction represented by the global account configuration instance 322 automatically whenever the user accesses SNET circle 304 via device 352 or 362, respectively, initializes communication with SNET 302 or SNET circle 304 via device 352 or 362, or the like. In addition, a user accessing SNET circle 304 via one of devices 352 and 362 can be provided with an option to resume the interaction represented by the global account configuration instance 322 upon interacting with some portion of SNET circle 304, including clicking an icon.

In addition, resources can be distributed and configured as needed to optimize interaction with the resources by the various devices. For example, as shown in FIG. 3, SNET infrastructure can include resource management and interaction control 310, which can manage hosting of instances of resources across various hosting locations within and without the SNET infrastructure 302. The control 310 can distribute, replicate, and remove instances of a resource as needed to support and to configure aspects of the interaction activities. Such configurations can be anticipatory, based on tracking of one or more interaction activities associated with various members and resources. For example, where elements of the SNET infrastructure, such as service 308, anticipate that a content item, currently hosted at server 330 in a high-resolution instance 332 and being accessed by a member associated with infrastructure 340 via device 352, may switch to interact with SNET circle 304 via device 362, control 310 can manage distribution of an instance of the content item to another hosting location to support optimal interaction with the content item via device 362. Distribution can include distributing an instance to a storage location, such as a server 380, located in a cloud 370 that is not part of the SNET infrastructure, such as a third-party service. In addition, an instance 382 of the content item distributed to another hosting location can be reformatted based on capabilities of the device 362; for example, instance 382 can be reformatted to a lower-resolution where access of the high-resolution instance 332 requires additional energy usage by device 362. As a result, where the member switches from accessing the instance 332 via the device 352 to interacting with SNET circle 304 via device 362, the representative view 366 provided to the member can automatically present an instance of the content item that the member was accessing via device 352, without requiring the member to re-establish access to the content item via navigation of some portion of the SNET circle 304. Access can be re-established on different devices simply by attempting to access the SNET or SNET circle 304 via the different devices. In some embodiments, a member accessing SNET circle 304 via a different device, such as device 362, can be presented with an option to resume access of resources previously accessed via device 352. Upon accepting the option, the member can immediately resume interactions with the resource, as the history of the interaction can be preserved by the global account configuration instance 322 based on information obtained by the service 308.

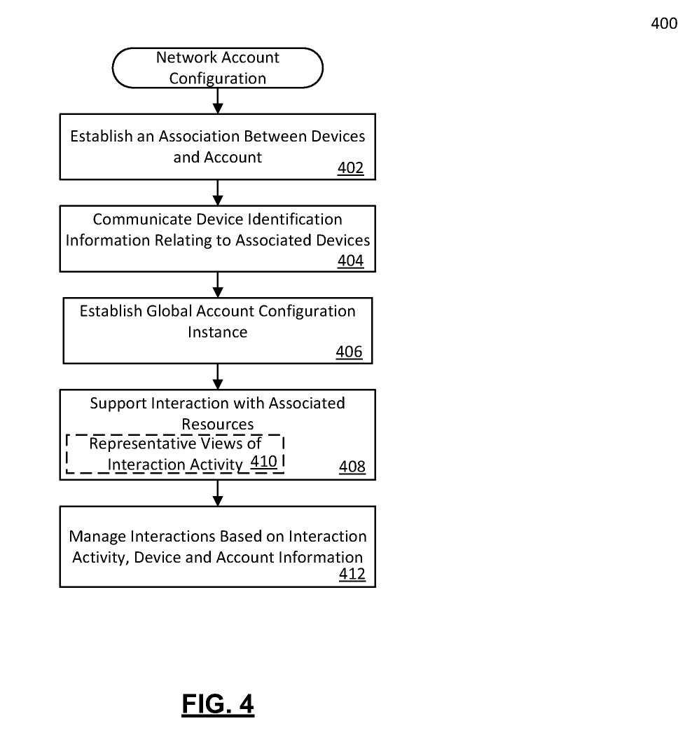

FIG. 4 is a logic diagram of a process 400 for supporting interactions with resources associated with a network and various devices associated with one or more network member accounts, in accordance with various embodiments. In some embodiments, process 400 is performed, in part or in full, by elements of a network infrastructure, SNET infrastructure, or the like, including services and applications supported by central or distributed processing systems. Process 400 can include configuring an account associated with at least one member, which can include, without limitation, a human user and a device. As shown in block 402, process 400 can include establishing an association (e.g., docking as a member of a network circle, associating with an existing member, etc.) between one or more devices and an account. Association can follow, or occur contemporaneously with, activation of a device, accessing the network using the device, and the like.

As shown in block 404, process 400 can include communication of information associated with a device to the network. The communicated information can comprise configuration settings associated with the associated account. For example, the configuration settings of a member's account can be configured, based on the communicated information associated with the member's associated device, to manage or control interactions with network resources via the device based on various aspects that can be related to capabilities of the device. For example, information indicating energy usage associated with “roaming” functionality of the device in remote locations can be used to establish configuration settings restricting access by the device in remote locations to lower resolution content items, limited access to certain network resources, etc.

As shown in block 406, process 400 can include establishing a global account configuration instance associated with the account. The global account configuration instance can provide an up-to-date representation of interactions between one or more members associated with the account. As shown in blocks 408-410, process 400 can include supporting interactions involving resources associated with the network. Such support can include supporting access to such resources by members via supporting associated devices, interactions with other members, network circles, etc. As shown in block 410, an interaction activity can be provided to one or more devices via one or more representative views. A user can seamlessly switch between associated devices to interact with one or more resources, such that the user can resume interactions at a second device where the user left off on the first device, as the global account configuration instance preserves the interaction activity where the user left off. Supporting such interactions can include distributing and formatting various resources, communications, and the like based on configuration settings associated with an account. For example, instances of a content item provided to a user via various supporting devices may have different formats based upon the capabilities and interaction restrictions associated with each device, as indicated in the configuration settings.

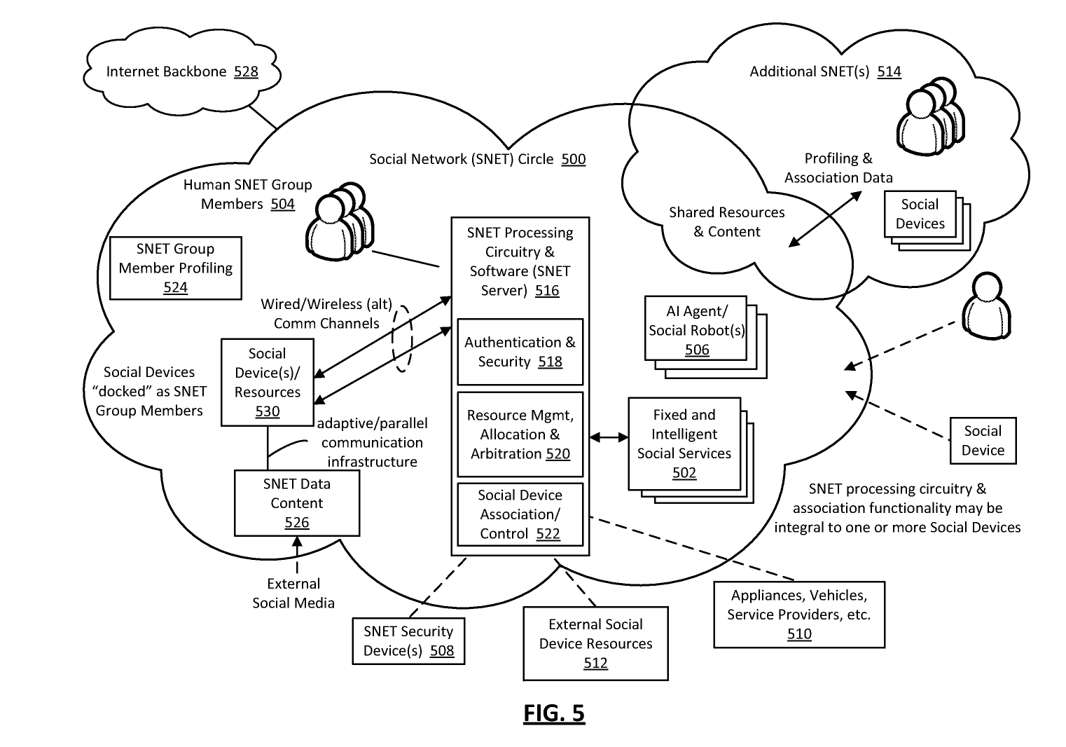

Referring to FIG. 5, a social network group/circle 500 (“SNET group” or “SNET circle”) comprising fixed and intelligent social services 502 is shown. Briefly, membership in the SNET group 500 may comprise fixed and intelligent social services 502, docked social devices/resources 530 and human SNET circle members 504, as well as proxies thereof. Further, SNET circle 500 nodes may include support services and software (e.g., applications) of various types participating as members. By way of example, SNET circle members might include artificial intelligence agents/social robots 506, SNET security device(s) 508, appliances, vehicles and service providers 510, external social device resources 512, common or authorized members/functionality of other SNET circles, etc. Further, access to specific content and resources of a SNET circle 500 may be shared with members of additional SNET(s) 514, including remote or web-based applications. Such access can be conditioned on acceptable profiling and association data. Similarly, social devices or individuals may be granted temporary or ad hoc memberships, with or without restricted access.

In the illustrated embodiment, formation, maintenance and operation of SNET circle 500 is performed by standalone or distributed SNET processing circuitry and software 516. It is noted that the “SNET processing circuitry” may comprise hardware, software, applications, or various combinations thereof, and be configurable to support various functionalities disclosed herein. Further, the SNET processing circuitry 516 may be included in a standalone server, server farm, cloud-based resources, and/or the various types of devices described below, and incorporate authentication and security functionality 518. In addition, specialized middleware may also be utilized by SNETs according to the disclosure, including standardized middleware and/or standardized communication protocols having an associated certification process. Interactions and interdependencies within the SNET circle 500 may involve one or more of an adaptive resource management, allocation and arbitration module 520, a social device association/control module 522 or docking service, and a SNET group member profiling module 524.

As described more fully below, distribution of internal and external SNET data content 526 can be accomplished in a variety of ways in accordance with various embodiments of the disclosure. For example, data distribution may involve an adaptive or parallel network communication/routing infrastructure involving a wide variety of communication protocols and wired and/or wireless communications channels, as well as one or more social devices/resources 530. SNET data content 526 may comprise, for example, various user-driven (advertising) channels, pictures, videos, audio communications, links, online text, etc. Access to such content, as well as communications with and remote interaction with docked social devices/resources 530 of the SNET group 500, may occur over an Internet backbone 528, cellular communication system, WAN, LAN, etc.

Exemplary social devices may be broadly categorized as either (i) social devices that include a user or SNET group interface sufficient to provide meaningful input to SNET interaction and (ii) social devices that support minimal or no user input relevant to SNET interaction. More particularly and without limitation, the first category may include computers, tablet devices, IPTVs, IPTV set top boxes, smart phones, servers, laptops, cloudbooks, network attached storage devices, gaming consoles, media players/sources, communication nodes (access points, routers, switches, gateways, etc.), user interface devices, power line communication (PLC) devices, etc. Such social devices may receive user input for SNET setup and management. The second category may include, again without limitation, printers, projectors, cameras and camcorders, scanners, speakers, headsets, smoke detectors, alarm systems, video cameras, mice, etc. In general, dockable social devices include any electronic device that could be operably coupled to or docked in a SNET group/sub-group via wired or wireless pathways to participate as a SNET member.

As will be appreciated, by docking social devices, members of a SNET circle may gain full or partial remote control and interaction with or via such devices via an authorized member SNET account. For example, family members authorized to participate in a “family” SNET circle may remotely interact with docked social devices via one or more associated SNET accounts. Other capabilities according to various embodiments of the disclosure include numerous novel features and attributes as described more fully elsewhere in the disclosure.

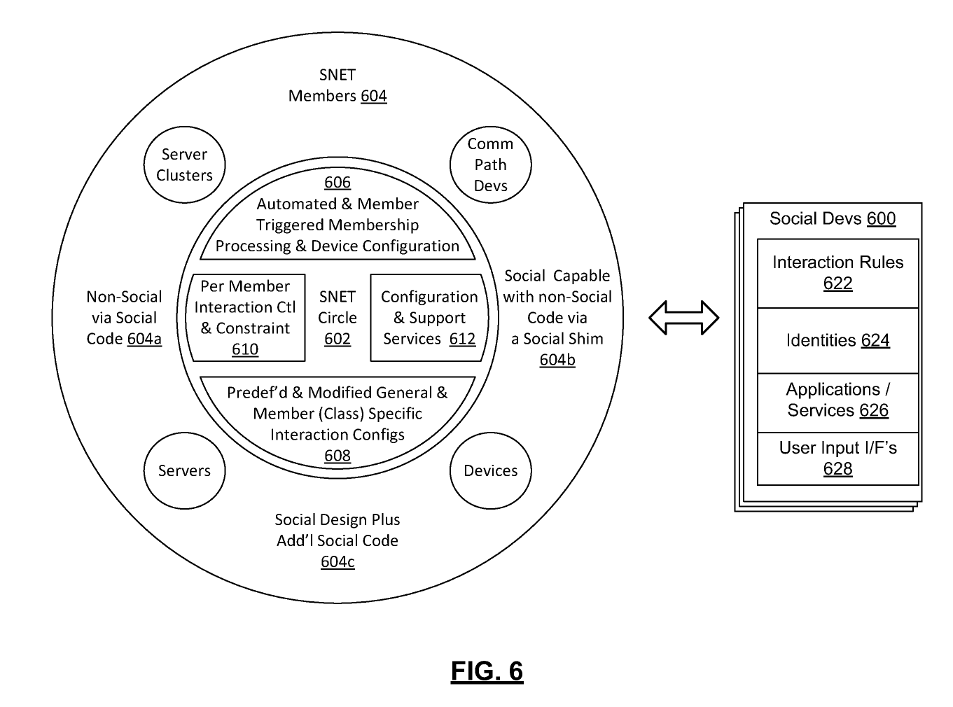

FIG. 6 illustrates an embodiment of a SNET circle 602 comprising a variety of members in accordance with the present disclosure. In this embodiment, membership in the SNET circle 602 may include a variety of SNET members 604 functioning in various capacities within the SNET circle 602. As will be understood, certain of the SNET members 604 may support direct or indirect associations and interactions between the SNET circle 602 and human members/non-members and social devices 600.

In the illustrated embodiment, SNET members (or nodes) 604 include one or more local or remote servers and server clusters that provide a support infrastructure/supporting system for SNET circle functionality and member operations (routing, data storage, services, dockable services, etc.). Communications within the SNET circle and with non-members may occur via dedicated or multi-function communication path devices.

SNET members 604 further include devices configured to operate as nodes within the SNET circle 602. Social functionality in such devices and other SNET members 604 can be implemented through various means. For example, a device may have integral hardware/firmware/software to support SNET circle interaction and member operations. Alternatively, a general purpose device 604a may include social code that enables participation in the SNET circle 602. In a further embodiment, a device 604b designed to include social functionality may participate in the SNET circle 602 through a combination of non-social code and a social shim layer or driver wrapper. In yet another embodiment, a member device 604c having a social design may utilize additional social code, including code specific to a SNET circle 602.

Participation in the SNET circle 602, which can include interaction with resources associated with the SNET circle 602, is supported through functionality that includes automated and member-triggered membership invitations and processing (membership management) 606. More particularly, membership management 606 may function to invite prospective members to participate in the SNET circle 602 through automatic, automated and member-triggered processes. For example, membership management 606 might be configured by a human user 600 to establish or modify a SNET circle 602 by automatically inviting/accepting SNET members having certain characteristics (such as new devices owned or controlled by the user or acquaintances of the user).

Processing of accepted invitations and unsolicited requests to join the SNET circle 602 may be conditioned upon input or authorization from an existing SNET member(s) 604 or social device 600 (e.g., through a user input interface 628). Similarly, membership management 606 may be configured to generate automated suggestions regarding which prospective members receive an invitation. Various other approaches, such as those described herein, can be used to establish membership in accordance with the disclosure.

Interaction with and visibility of resources associated with a SNET circle 602, including services, content, and data, may be managed through general and member class-specific interaction configurations 608. For example, if membership in the SNET circle 602 includes family members and associated devices, a uniform interaction configuration (or separate device and human configurations) could be applied across the class in an automatic or automated manner. In other embodiments, interaction control and constraints 610 are imposed on a per-member basis. In the illustrated embodiment, social devices 600 include one or more of interaction rules 622, device or user identification information 624, applications and services 626, and user input interfaces 628.

The SNET circle 602 may offer a wide variety of configuration and support services 612, including both internal and external services accessible by SNET members 604. By way of example and in addition to the support services described elsewhere, the SNET circle 602 may offer payment processing services, storage and backup services, robotic control functions, digital assistants, and other services (certain of which may themselves participate as members) between full members and/or authorized guest members and visitors. In certain embodiments, configuration and support services 612 may themselves participate or be selectable to participate as members of the SNET circle 602. As with other resources of the SNET circle 602, access control and constraints on configuration and support services 612 may be applied to individual members or classes of members.

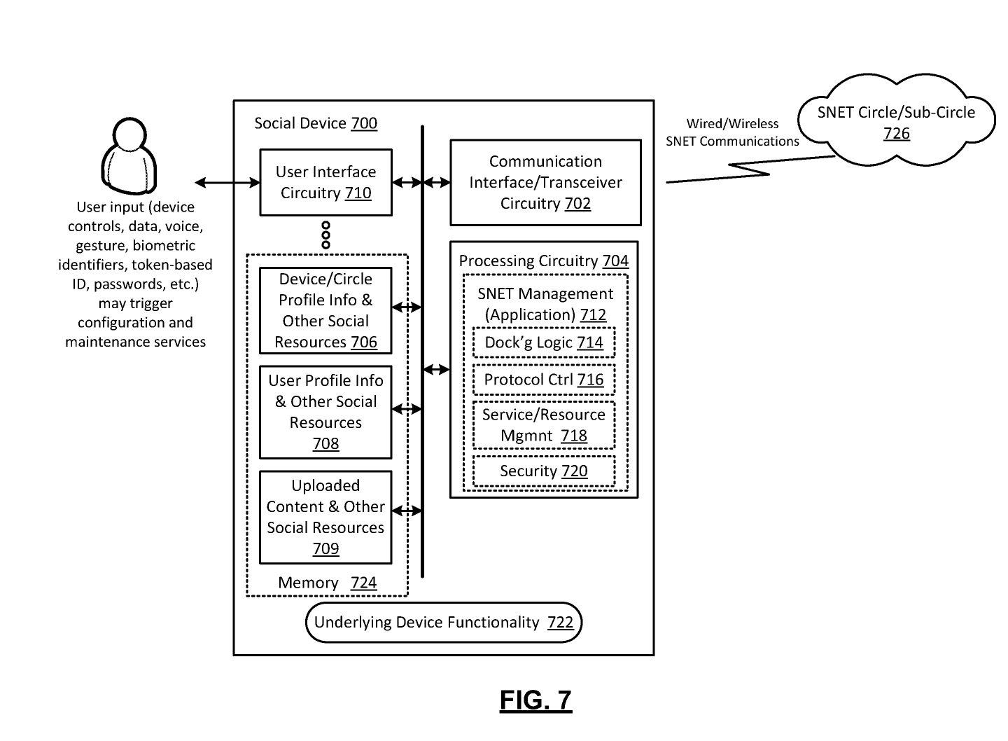

FIG. 7 is a schematic block diagram of an embodiment of a social device comprising integral functionality operable to support social network group/sub-group membership and communications in accordance with the disclosure. In the illustrated embodiment, a communication interface and transceiver circuitry 702 is operable to perform wired or wireless communications between the social device 700 and a SNET circle/sub-circle 726 over one or more communication channels. Depending on the capabilities and configuration of the social device 700, communications with a SNET may be unilateral or bidirectional/interactive, and utilize either a proprietary or standardized communication protocol. Communications may include, without limitation, device profile information, user and SNET circle profile information, servicing information, control signals, resources associated with an SNET circle/sub-circle, audio/video content, interactions with hosted service data, user data, relayed information, etc.

The social device 700 further includes processing circuitry 704 operable to process and manage communications, services and associations between the device and other entities including members of a SNET circle/sub-circle 726, third parties, software agents, etc. More particularly, the processing circuitry 704 may include, for example, a software management application 712 comprising one or more of docking logic 714 (including support for device discovery and configuration protocols such as described below), communication protocol control 716, service and resource management 718, and security/authentication 720 functionality.

The social device 700 further may utilize that may take many forms and be maintained in static or dynamic memory 724. Such profile information enables a social device and/or user to present an image of itself and its capabilities to other members of a SNET. In particular, for example and without limitation, device/group profile information 706, user profile information 708, and instances of uploaded content items 709 and other resources may be utilized in various ways in accordance with the disclosure to facilitate a variety of interactions. Depending on the capabilities and requirements of a particular device (and other members of a SNET), a device or user profile may be static or dynamic.

In certain embodiments, the social device 700 may interact with a user(s) via user interface circuitry 710. User input to the social device 700 may include, for example, data entry through a keypad, touchscreen, remote control device, gaming controller, device control buttons, voice or gesture commands, storage device, etc. For example, voice or gesture commands may be utilized to trigger intelligent services, configuration and maintenance services, etc. Authorized access to or control of the social device 700 can be facilitated through unique biometric identifiers, passwords, token-based identification, trusted authorities or documents such as a driver's license or passport, and like authentication means.

The social device 700 may perform core or underlying functionality 720 (e.g., a social appliance, security device, vehicular communication node, etc.). Alternatively, the social device may primarily function as a social networking interface or communication device, or be programmable to perform specific functions within a SNET group/sub-group.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. A networking system that supports interaction activities associated with a plurality of members and a plurality of content items, the networking system comprising:
a first service operable to support a global configuration instance of an account associated with a member, the global configuration instance includes a representation of an interaction activity between the member and a content item; and
a second service operable to support managing a plurality of representative views of the interaction activity based on the global configuration instance and configuration information associated with the account.

2. The networking system of claim 1, the second service operable to support providing a plurality of individual representative views of the interaction activity to corresponding individual devices, each individual representative view is configured to provide a separate representation of the interaction activity based on the global configuration instance and configuration information associated with the corresponding individual device, each corresponding individual device is associated with the account.

3. The networking system of claim 2, each of the plurality of individual representative views supports access to a selected one of a plurality of instances of the content item based on configuration information associated with the corresponding individual device.

4. The networking system of claim 2, wherein:
the global configuration instance includes a history of the interaction activity for a predetermined period of time; and
the second service is operable to support continuing an ongoing interaction activity from a selected historical point in the interaction activity via interaction with at least one of the plurality of individual representative views.

5. The networking system of claim 3, the second service is operable to support selectively providing at least one of the plurality of individual representative views to the corresponding individual device based on an interaction by the member with the one of the individual representative views.

6. The networking system of claim 3, the each of the plurality of representative views supports access to the selected one of a plurality of instances of the content item based on energy usage associated with interaction between the member and the selected one of the plurality of instances through the corresponding individual device.

7. The networking system of claim 6, the second service operable to support distributing the selected one of a plurality of instances to be hosted at a hosting location based on proximity of the corresponding individual device to the hosting location.

8. The networking system of claim 3, each of the plurality of representative views supports access to a selected one of a plurality of instances of the content item based on location information associated with the individual device.

9. The networking system of claim 1, the global configuration instance is updated continuously based on monitoring of the interaction activity.

10. A server device that supports interactions between a member of a social networking system and resources associated with the social networking system, the social networking system including a plurality of network nodes, the server device comprising:
an account management module configured to manage a global configuration instance associated with the member, the global configuration instance includes a representation of interaction activities between the member and at least one of the resources; and
an interaction control module configured to manage configuration information associated with the member to associate each of a plurality of devices associated with the member with corresponding optimal representative views of the interaction activities.

11. The server device of claim 10, comprising:
a tracking module configured to generate tracking data associated with monitoring the interaction activities; and
the account management module configured to manage a global configuration instance based at least in part on the tracking data.

12. The server device of claim 10, the interaction control module configured to manage providing a plurality of individual representative views to corresponding individual devices, each individual representative view is configured to provide a separate representation of the interaction activity based on the global configuration instance and configuration information associated with the corresponding individual device, each corresponding individual device is associated with the member.

13. The server device of claim 12, wherein:
the global configuration instance includes a history of the interaction activities for a predetermined period of time; and
the interaction control module is configured to support continuing an ongoing interaction activity from a selected historical point in the history of the interaction activities.

14. The server device of claim 13, the each of the plurality individual representative views supports access to a selected one of the resources based on energy usage associated with interaction between the member and the selected one of the resources through the corresponding individual device.

15. A social networking system that supports interactions with a first social networking circle, the first social networking circle having a plurality of members, the social networking system comprising:
a processing system operable to manage a plurality of separate representative views of an interaction activity between one of the plurality of members and a social resource associated with the first social networking circle based on a global representation of the interaction activity;
the processing system operable to provide each of the plurality of representative views to the one of the plurality of members via a corresponding one of a plurality of social devices.

16. The social networking system of claim 15, the processing system further operable to provide the plurality of separate representative views to the one of the plurality of members via separate corresponding social devices based on separate interaction rights associated with each of the separate corresponding social devices.

17. The social networking system of claim 16, at least some of the plurality of separate representative views provide the one of the plurality of members access to separate instances of the social resource based on configuration information associated with the one of the plurality of members.

18. The social networking system of claim 15, wherein:
the global representation includes a history of the interaction activity for a predetermined period of time; and
the processing system operable to support accessing the interaction activity, via at least one of the plurality of representations, from a selected historical point in the interaction activity.

19. The social networking system of claim 15, the processing system operable to respond to the one of a plurality of members docking a first social device with the first social networking circle by providing one of the plurality of representative views to the one of a plurality of members via the first social device.

20. The social networking system of claim 16, the processing system operable to distribute separate instances of the social resource to be hosted on separate hosting locations based on proximities of the separate corresponding social devices to the separate hosting locations.
